(19) United States
(12) Patent Application Publication
(10) Pub. No.: US 2008/0060234 A1
(43) Pub. Date: Mar. 13, 2008

(54) Message display panel structure

(75) Inventors: Ching-Pao Chou, Taipei (TW); Chung-Chin Yang, Taipei (TW)

Correspondence Address: Troxell Law Office Pllc, Suite 1404, 5205 Leesburg Pike, Falls Church, VA, 22041, US

(73) Assignee: Formolight Technologies, Inc.

(21) Appl. No.: 11/600,923

(22) Filed: Nov. 17, 2006

(30) Foreign Application Priority Data
Sep. 8, 2006 (TW) 095216114

(51) Int. Cl. G09F 7/00

(52) U.S. Cl. 40/452

(57) ABSTRACT

The present invention provides a message display panel structure including a combination outer frame and a waterproof housing. Grooved joining portions are located on a periphery of an inner side of the combination outer frame, and a rear panel is located at a rear side of the combination outer frame. The waterproof housing is configured with a plurality of light emitting display modules, a plurality of bottom housings, a power supply unit, a signal control box and a signal scanning panel. A rear side of the waterproof housing is mutually joined to the joining portions of the combination outer frame, fixing position thereof, by means of rotating shaft L strips. Accordingly, the present invention is provided with effectiveness of a structure that is simple and fast to assemble, provides labor saving maintenance, has excellent waterproofing quality and improves safety.

### BACKGROUND OF THE INVENTION

1. Field of the Invention

The present invention relates to an improved message display panel structure, and more particularly to a structure that uses a combinatorial configuration of a combination outer frame and a waterproof housing, wherein the waterproof housing is configured with a plurality of light emitting display modules, a plurality of bottom housings, a front panel, a terminal block, a power supply unit, a signal control box, a signal scanning panel and a rear panel, thereby providing the present invention with effectiveness of a structure that is simple and fast to assemble, is convenient to dismantle, has excellent waterproofing quality, provides labor saving maintenance and improves safety, moreover, it is applicable for use in message display panels installed in markets, restaurants, competition areas, all kinds of public places, and so on, or for use in similar articles.

2. Description of the Prior Art

A message display panel of prior art primarily comprises a housing and a plurality of light emitting modules, wherein a containing space defined interior of the housing enables disposing a power supply unit and a signal scanning panel therein. Moreover, each of the light emitting modules is electrically connected to the power supply unit and the signal scanning panel to enable controlling light emitting state of each of the light emitting modules. However, although the message display panel is able to display all kinds of numerals, patterns or messages, nevertheless, when the message display panel is installed on a wall and maintenance is required, the entire message display panel must be dismantled, and only then can a rear panel be opened to carry out maintenance on the message display panel. Hence, space limitations result in the inconvenience of dismantling. Moreover, the entire message display panel is considerably heavy, thus, a single person is frequently unable to complete dismantling of the message display panel. Furthermore, a combination outer frame of the message display panel is only coated with silica gel, thus waterproofing is poor. Hence, in practical use there are still many areas that need improvement and advancement.

### SUMMARY OF THE INVENTION

A primary objective of the present invention is to provide an improved message display structure that uses a combinatorial configuration of a combination outer frame and a waterproof housing, wherein the waterproof housing is configured with a plurality of light emitting display modules, a plurality of bottom housings, a front panel, a terminal block, a power supply unit, a signal control box and a signal scanning panel, thereby providing the present invention with effectiveness of a structure that is simple and fast to assemble, and is convenient to dismantle, thus substantially improving practicability and convenience of the entire structure.

Another objective of the present invention is to provide the improved message display structure with housing clasp hooks located at upper and lower portions of a rear end of the waterproof housing respectively corresponding to arc extended slots of an inner edge of an upper portion of the combination outer frame and hook grooves of an inner edge of a lower portion of the combination outer frame, thereby facilitating dismantling by first using the housing clasp hooks located on the lower portion of the rear end of the waterproof housing to hook and fix position with the hook grooves of the inner edge of the lower portion of the combination outer frame to prevent the waterproof housing configured with the plurality of light emitting display modules from directly sliding, and at the same time uses an upper portion of the waterproof housing and the arc extended slots of the inner edge of the combination outer frame to facilitate extracting and inserting the waterproof housing, thereby providing the present invention with better labor saving operation and improved safety, and increasing convenience and safety of construction when working with the message display panel.

Yet another objective of the present invention is to provide the improved message display structure with the light emitting display modules configured with a plurality of sunshade covers, a transparent inner cover and a plurality of light emitting component groups, which enable the display of all kinds of numerals, patterns or messages. Moreover, the transparent inner cover is tightly screwed to the front panel using a plurality of screw members, which enables quick dismantling, thus maintenance can be carried without the need for professional personnel, thus increasing convenience and practicability of use.

Yet another objective of the present invention is to provide the improved message display structure with a configuration wherein the bottom housings are tightly joined to the light emitting display modules, and the light emitting component groups are respectively configured with the sunshade cover, thereby providing the present invention with excellent waterproofing quality and capability to display messages.

In order to achieve the aforementioned objectives, the improved message display panel structure of the present invention comprises a combination outer frame and a waterproof housing. Joining portions are located on a periphery of an inner side of the combination outer frame, and a rear panel is located at a rear side of the combination outer frame. The waterproof housing is configured with a plurality of light emitting display modules, a plurality of bottom housings, a front panel, a terminal block, a power supply unit, a signal control box, a signal scanning panel and a housing back panel. Wherein each of the light emitting display modules of a front portion of the waterproof housing is configured with a plurality of sunshade covers, transparent inner shades and a plurality of light emitting component groups. Each of the light emitting display modules is fixedly joined to the front panel at a rear of the bottom housings using the plurality of screw members. The terminal block on the front panel is respectively electrically connected to the power supply unit, the signal scanning panel and electric outlets of each of the light emitting display modules. A plurality of fixing rotating shaft assemblies are located on a periphery of a rear side of the waterproof housing. Accordingly, the present invention is provided with effectiveness of a structure that is simple and fast to assemble, is convenient to dismantle, provides labor saving maintenance, has excellent waterproofing quality and improves safety.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a front view of an embodiment according to the present invention.

FIG. 2 shows a cross-sectional schematic view of the embodiment depicting a basic structure according to the present invention.

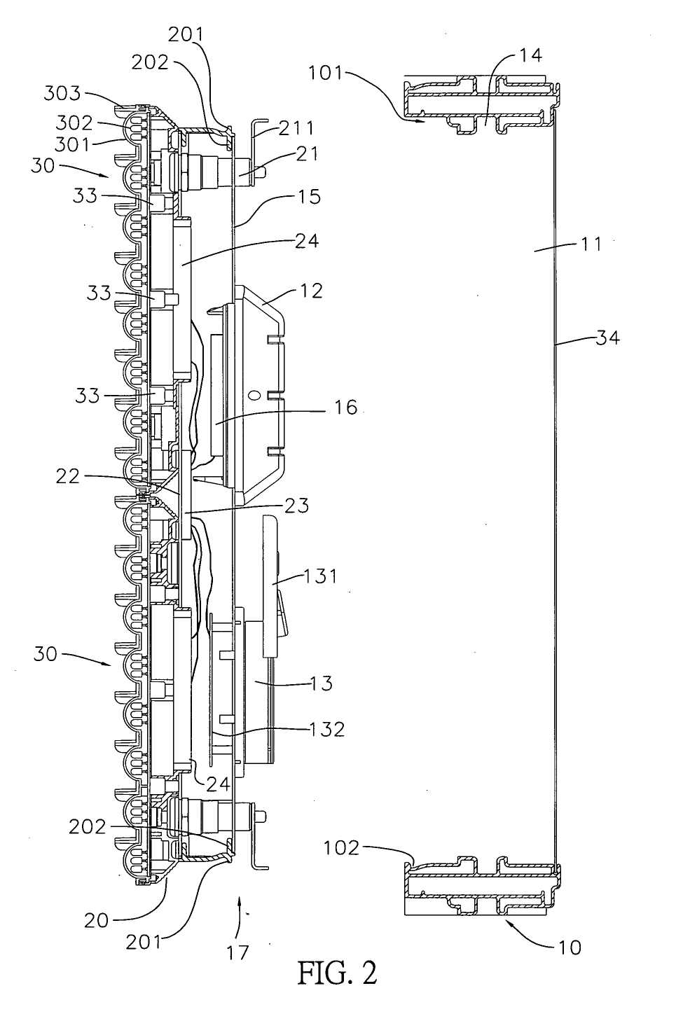

FIG. 3 shows a cross-sectional schematic view of the embodiment according to the present invention.

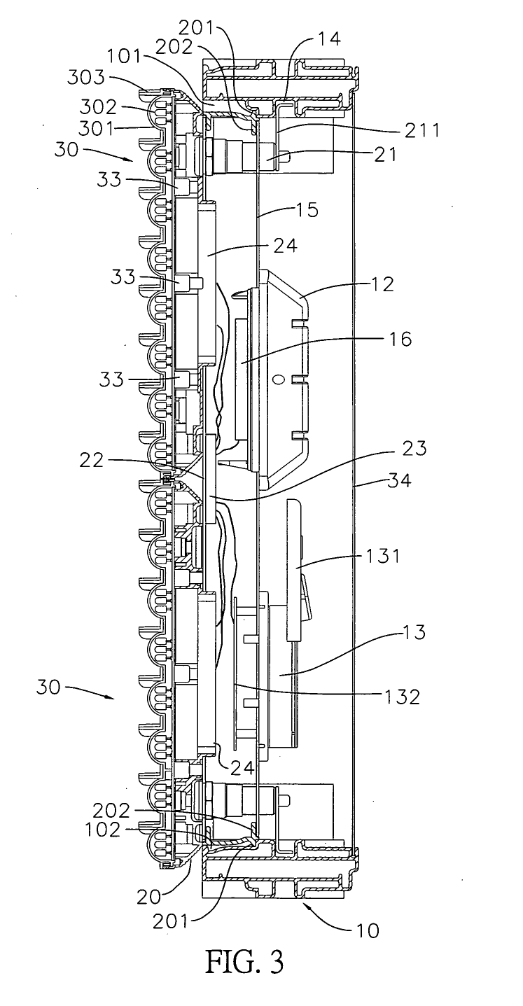

FIG. 4 shows a disposition-plan schematic view of the embodiment depicting power supply units and signal scanning panels within combination outer frames according to the present invention.

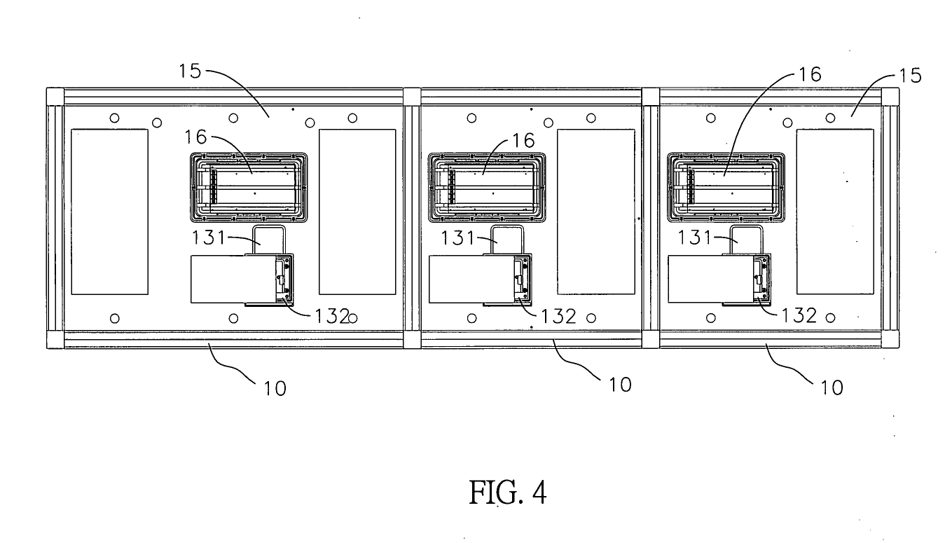

FIG. 5 shows a schematic view of the embodiment of the present invention in use.

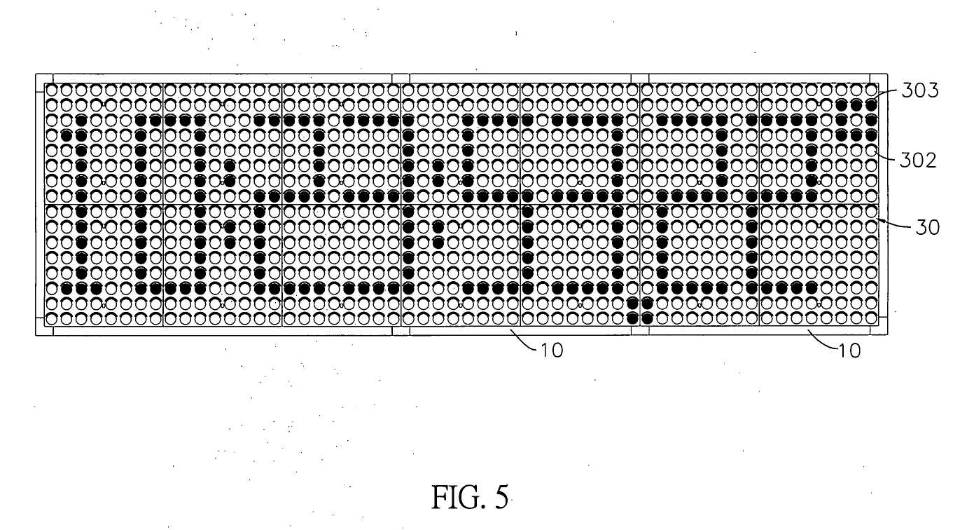

FIG. 6 shows a schematic view of the embodiment of the present invention during maintenance.

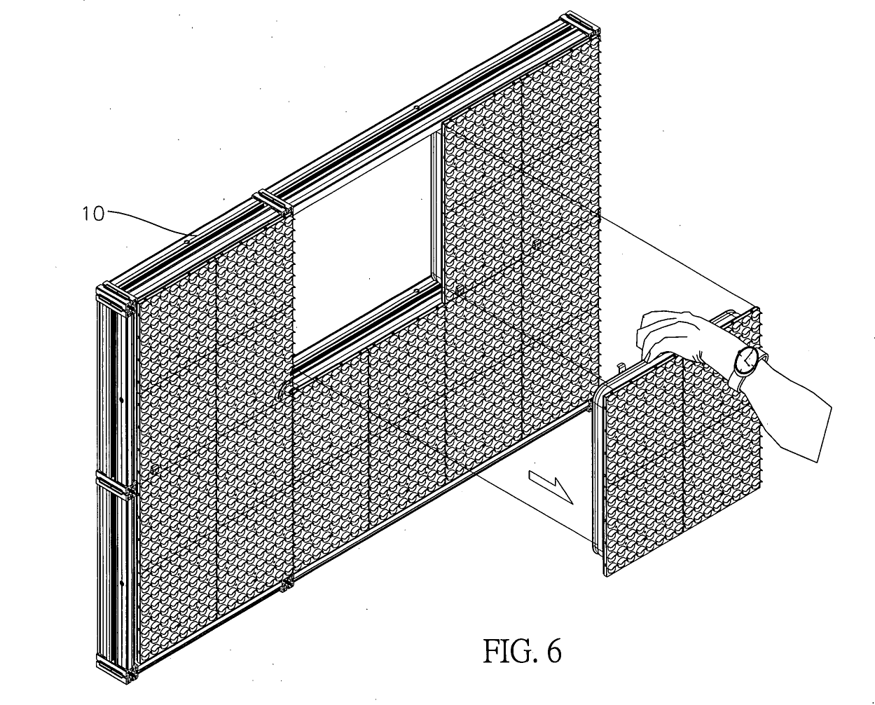

### DETAILED DESCRIPTION OF THE PREFERRED EMBODIMENTS

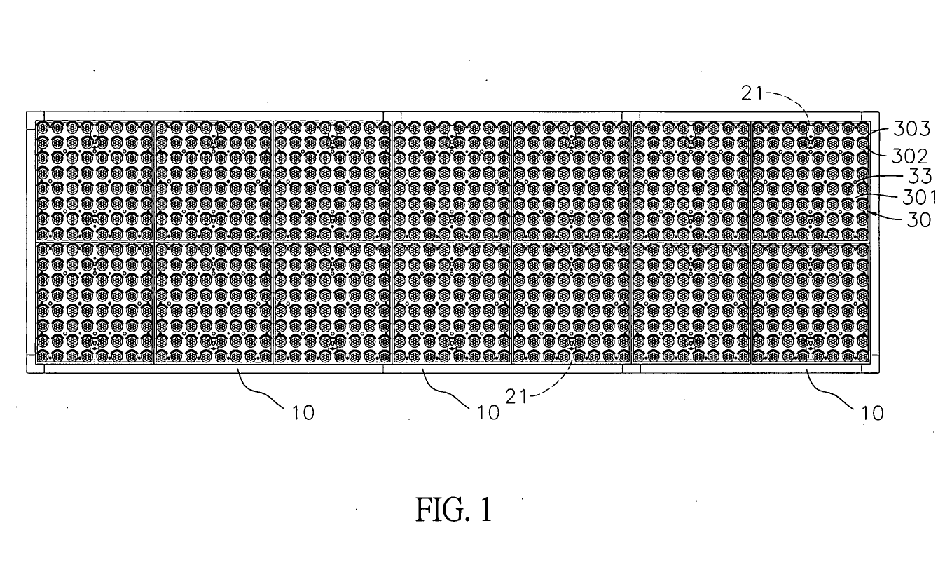

Referring to FIGS. 1˜6, which show an improved message display panel structure of the present invention, comprising:

A combination outer frame 10, a rear side of which is provided with a rear panel 34, and interior of the combination outer frame 10 forms a containing space 11. Joining portions 14 (the joining portions 14 of the combination outer frame 10 are grooves) located on a periphery of an inner side of the combination outer frame 10 are used for joining and positioning. Arc extended slots 10 are formed on an inner edge of an upper portion of the combination outer frame 10, and hook grooves 102 are formed on an inner edge of a lower portion of the combination outer frame 10.

A waterproof housing 17 configured with a plurality of light emitting display modules 30, a plurality of bottom housings 20, a front panel 22, a terminal block 23, a power supply unit 16, a signal control box 13 and a signal scanning panel 132, wherein each of the light emitting display modules 30 of a front portion of the waterproof housing 17 is configured with a plurality of sunshade covers 303, transparent inner shades 301 and a plurality of light emitting component groups 302. Each of the light emitting component groups 302 comprises a distribution of a plurality of LED (light emitting diode) lamps. Each of the light emitting display modules 30 is fixedly joined to the front panel 22 at a rear of the bottom housings 20 using a plurality of screw members 33. The rear of the bottom housings 20 is joined to the front panel 22, and the terminal block 23 and electric outlets 24 of the plurality of light emitting modules 30 are located on the front panel 22. A plurality of fixing rotating shaft assemblies 21 are located on a periphery of a rear side of the waterproof housing 17, wherein the fixing rotating shaft assemblies 21 are rotating pins, and a rotating shaft L strip 211 is located at an end of each of the rotating pins. The rotating shaft L strips 211 are used to fixedly fasten into the respective grooves in the joining portions 14 of the combination outer frame 10. Housing clasp hooks 201 are located on an upper and a lower rear end of the waterproof housing 17 respectively corresponding to the arc extended slots 101 of the inner edge of the upper portion of the combination outer frame 10 and the hook grooves 102 of the inner edge of the lower portion of the combination outer frame 10, thereby facilitating hooking and fixing position when dismantling. A stop portion 202 corresponding to each of the housing clasp hooks 201 located on the upper and lower rear end of the waterproof housing 17 inwardly extends at a position thereof, which are able to clasp and fix position a back panel 15 interior of the combination outer frame 10. When the waterproof housing 17 and the combination outer frame 10 are tightly joined together, the containing space 11 interior of the combination outer frame 10 contains the power supply unit 16, the signal control box 13 and the signal scanning panel 132, wherein the power supply unit 16 and the signal control box 13 are disposed on the back panel 15, and a protective cover 12 and a sliding cover 131 cover the power supply unit 16 and the signal control box 13 respectively, thereby protecting the power supply unit 16 and the signal control box 13 from moisture and humidity.

Referring again to FIGS. 1˜6, according to the aforementioned structural configuration of the improved message display panel structure, the present invention is characterized in that it uses a combinatorial configuration of the combination outer frame 10 and the waterproof housing 17, and joins the light emitting display modules 30 to the front panel 22 at the rear of the bottom housing 20, and respectively electrically connects the terminal block 23 on the front panel 22 to the power supply unit 16, the signal scanning panel 132 and the electric outlets 24 of each of the light emitting display modules 30, thereby utilizing the effectiveness of the convenient dismantling configuration between the waterproof housing 17 and the combination outer frame 10 to enable each of the light emitting display modules 30 to be dismantled from a front portion of the message display panel, thus eliminating the inconvenience of prior art resulting from having to dismantle the entire message display panel when installed on a wall in order to open a rear of the message display panel for maintenance. Furthermore, the present invention uses the housing clasp hooks 201 located on the upper and the lower rear end of the waterproof housing 17 respectively corresponding to the arc extended slots 101 of the inner edge of the upper portion of the combination outer frame 10 and the hook grooves 102 of the inner edge of the lower portion of the combination outer frame 10, thereby facilitating dismantling by first using the housing clasp hooks 201 located on the lower portion of the rear end of the waterproof housing 17 to hook and fix position with the hook grooves 102 of the inner edge of the lower portion of the combination outer frame 10 to prevent the waterproof housing 17 configured with the plurality of light emitting display modules 30 from directly sliding and causing accidents. At the same time, the present invention uses the arc extended slots 101 located on the inner edge of the upper portion of the combination outer frame 10 to facilitate extracting and inserting the waterproof housing 17, thereby labor saving on maintenance and improving safety, and increasing convenience and safety of construction when working with the message display panel. Furthermore, the light emitting display modules 30 configured with the plurality of sunshade covers 303, the transparent inner covers 301 and the plurality of light emitting component groups 302 enable the display of all kinds of numerals, patterns or messages. Moreover, the transparent inner covers 301 are respectively screwed tight to the front panels 22 using the plurality of screw members 33. Hence, if a malfunction occurs in any one of the light emitting component groups 302, then each of the screw members 33 on the transparent inner cover 301 need only be unscrewed to quickly carry out maintenance and replacement. Hence, in actual practice, there is no need for professional staff for maintenance operations. Furthermore, configuration of the sunshade covers 303 respectively located on an upper edge of the light emitting component groups 302 provides excellent waterproofing quality and message display capability. Hence, the present invention is provided with effectiveness of a structure that is simple and fast to assemble, is convenient to dismantle, has excellent waterproofing quality, provides labor saving maintenance and improves safety, thereby increasing practicability, convenience and safety of the entire configuration.

According to the aforementioned detailed description, persons familiar with related art are able to easily understand that the present invention can clearly achieve the aforementioned objectives, and evidently complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A message display panel structure comprising:
a combination outer frame, a rear side of which is provided with a rear panel, and interior of the combination outer frame forms a containing space, joining portions located on a periphery of an inner side of the combination outer frame are used for joining and positioning; and
a waterproof housing configured with a plurality of light emitting display modules, a plurality of bottom housings, a front panel, a terminal block, a power supply unit, a signal control box, a signal scanning panel and a housing back panel, wherein each of the light emitting display modules of a front portion of the waterproof housing is configured with a plurality of sunshade covers, transparent inner shades and a plurality of light emitting component groups; a rear of the bottom housings is joined to the front panel, the terminal block is located on the front panel, and the terminal block is respectively electrically connected to the power supply unit, the signal scanning panel and electric outlets of each of the light emitting display modules;
moreover, a plurality of fixing rotating shaft assemblies are located on a periphery of a rear side of the waterproof housing, which enable mutual joining with and fixing position to the joining portions of then combination outer frame.

2. The message display panel structure according to claim 1, wherein the joining portions of the combination outer frames are grooves, and the fixing rotating shaft assemblies of the waterproof housing are rotating pins, and an end of each of the rotating pins is configured with a shaft L strip, which enable fixedly clasping into the grooves of the combination outer frame and fix position therewith.

3. The message display panel structure according to claim 1, wherein at least one housing back panel is located within the containing space of the combination outer frame, and the containing space is able to contain the power supply unit and the signal control box of the rear side of the waterproof housing.

4. The message display panel structure according to claim 1, wherein a sliding cover is located on the signal control box.

5. The message display panel structure according to claim 3, wherein a sliding cover is located on the signal control box.

6. The message display panel structure according to claim 1, wherein arc extended slots are formed on an inner edge of an upper portion of the combination outer frame, and hook grooves are formed on an inner edge of a lower portion of the combination outer frame, housing clasp hooks are located on upper and lower portions of a rear end of the bottom housings corresponding to the arc extended slots of the inner edge of the upper portion of the combination outer frame and the hook grooves of the inner edge of the lower portion of the combination outer frame, thereby facilitating hooking and fixing position when dismantling.

7. The message display panel structure according to claim 6, wherein a stop portion corresponding to each of the housing clasp hooks located on the upper and lower rear end of the waterproof housing inwardly extends at a position thereof, which are able to clasp and fix position the housing back panel interior of the combination outer frame.

8. The message display panel structure according to claim 1, wherein the plurality of light emitting display modules are respectively fixedly screwed to a front panel using a plurality of screw members.

9. The message display panel structure according to claim 1, wherein sunshade covers are respectively located on upper edges of the plurality of light emitting component groups.

10. The message display panel structure according to claim 1, wherein the light emitting component groups use a plurality of LED (light emitting diode) lamps.

11. The message display panel structure according to claim 9, wherein the light emitting component groups use a plurality of LED (light emitting diode) lamps.
